(19) United States
(12) Patent Application Publication
(10) Pub. No.: US 2024/0410733 A1
(43) Pub. Date: Dec. 12, 2024

(54) VIBRATORY BEAN DOSER

(71) Applicant: Barrett Anderies, San Francisco, CA (US)

(72) Inventor: Barrett Anderies, San Francisco, CA (US)

(21) Appl. No.: 18/804,558

(22) Filed: Aug. 14, 2024

Related U.S. Application Data
(63) Continuation of application No. PCT/US2023/012901, filed on Feb. 13, 2023.
(60) Provisional application No. 63/310,439, filed on Feb. 15, 2022.

(51) Int. Cl. G01F 11/18; G01F 11/24

(52) U.S. Cl. CPC G01F 11/18; G01F 11/24

(57) ABSTRACT

A vibratory dosing system 16 with a dosing chute 24 having a first dosing mechanism 16A and a second dosing mechanism 16B, each dosing mechanism 16A, 16B with a first end 41 proximate a hopper 12 and a second end 43 of each dosing mechanism 16A, 16B is proximate an exit chute 24. One or both dosing chutes may have a ramp 17 portion. A vibratory driver is coupled proximate the second end 43 of one or both dosing mechanisms 16A, 16B and is configured to vertically move the second end 43 of one or both dosing mechanisms 16A, 16B to vibrate one or both dosing mechanisms 16A, 16B; and elastic attachment mechanisms 29 provide an asymmetric suspension for the dosing system 16 to reduce vibratory coupling between the first and second dosing mechanisms 16A, 16B. The dosing system 16 may be provided in operable connection with or otherwise coupled to a hopper 12 and scale 18 for measuring and dispensing a precise pre-selected weight of coffee beans.

### CROSS-REFERENCE TO RELATED APPLICATION

This application claims the benefit of and is a bypass continuation of PCT/US2023/012901, filed on Feb. 13, 2023, and published on Aug. 24, 2023, as WO 2023/0158608, designating the U.S., and claiming priority to U.S. provisional patent application Ser. No. 63/310,439 filed on Feb. 15, 2022, the contents of which are incorporated herein in their entirety.

### BACKGROUND

The present invention relates to devices for measuring and dispensing precise amounts of small dry goods, and more specifically to a vibratory dosing system for measuring and dispensing a precise amount of coffee beans.

When brewing coffee, the beans are generally measured by weight as it is a more reliable practice than using volume-based measurements such as cups or tablespoons. Coffee beans have different masses as a result of the roasting process and resultant moisture content. To brew great coffee, it is imperative to know how much to use. If too much coffee is used when brewing, the final brew can be under-extracted and the brewed coffee may have a sour or salty taste. If not enough coffee is used, the brewed coffee will be weak or watery.

Prior art devices exist to allow for the weighing of coffee beans in the home for the average user. However, such devices use rotating wheel and auger designs to dispense beans for weighing. While relatively simple to implement, the spacing and size of gear teeth in such devices dictates the minimum number/volume of beans that can be dispensed at a time. This space must be carefully calibrated to a single bean volume, which is not feasible due to varied bean sizes, and thus more than one bean will occasionally or always be dispensed. Such designs are also prone to jamming.

### SUMMARY

An aspect of the present disclosure relates to an automatic precision bean dosing device comprising a housing having a base having an opening therein; a reservoir supported on the base; a chassis supporting a dosing chute for transferring one or more beans received therein to the reservoir supported by the base, wherein the dosing chute is a vibratory dosing chute coupled with a vibratory driver for vibrating the dosing chute; and a scale for weighing the one or more beans transferred from the dosing chute to the reservoir.

In one or more embodiments, the dosing chute is configured to dispense approximately 10 to 40 grams of beans with a precision of +/−0.2 grams or less for household uses.

In one or more embodiments, the reservoir may be a manually placed cup or an internally integrated bucket supported on the device via a load cell and/or scale.

The dosing chute comprises a first dosing chute and a second dosing chute and one or more elastic attachments providing an asymmetric suspension for the dosing chute to reduce vibratory coupling between the first and second dosing chutes.

The reservoir is configured to hold a selected amount of beans transferred thereto and further configured to automatically release the beans when the weight of beans in the reservoir meets a preset weight.

The first dosing chute is configured for dosing a first selected quantity of beans and the second dosing chute is configured for precision dosing of a second selected quantity of beans and, wherein the first quantity of beans is greater than the second quantity of beans.

The vibratory driver is positioned at one end of the dosing chute to generate asymmetric displacement along a length of the dosing chute.

Beans are transferred from the hopper into a first end of the dosing chute and wherein the first end of the dosing chute is fixed to a chassis by a flexible mount to restrict movement of the dosing chute at the first end.

A second end of the dosing chute comprises a vibratory driver oriented to provide vertical motion at the second end of the dosing chute and wherein the one or more beans travel from the hopper to the first end of the dosing chute, along a length thereof and to the second end of the dosing chute and to the exit chute positioned at the second end of the dosing chute.

The vibratory driver comprises an eccentric rotating mass vibration motor or linear resonant actuator to provide vertical motion to at least a portion of the length of the dosing chute originating at the second end of the dosing chute.

The second dosing chute comprises a curvature and width narrower than the first dosing chute such that the one or more beans travel a length of the second dosing chute in a single file manner.

The first dosing chute comprises a ramp at a first end for receiving beans from the hopper and wherein each of the first and second dosing chutes is oriented perpendicular to the direction of gravity at an exit end of the dosing chute proximate the exit chute.

Another aspect of the present disclosure relates to a vibratory dosing system comprising a dosing chute having a first dosing mechanism and a second dosing mechanism, the first dosing mechanism comprising a ramp at a first end and wherein a second end of each dosing mechanism is proximate an exit chute; a vibratory driver coupled proximate the second end of one or both dosing mechanisms and configured to vertically move the second end of one or both dosing mechanisms to vibrate one or both dosing mechanism; and one or more elastic attachments mounted on an opposing end of the first and second dosing mechanisms from the vibratory driver for providing an asymmetric suspension for the dosing chute or to reduce vibratory coupling between the first and second dosing mechanisms.

A receptacle below the dosing chute is configured to receive material from the dosing chute and wherein the receptacle comprises a floor that is movable to release material from the receptacle.

A scale may be integrated into the receptacle and operably connected to the movable floor of the receptacle.

A base is connectable to the dosing chute and receptacle, the base comprising an aperture therein for allowing material released from the receptacle to be delivered therethrough.

Yet another aspect of the present disclosure relates to an automatic precision bean dosing device, the device having a chassis comprising a vibratory dosing chute for transferring one or more beans provided thereto to an exit thereof, wherein the vibratory dosing chute has a first end and a second end, and wherein the second end is positioned above a reservoir for receiving beans from the dosing chute; a vibratory driver coupled to a second end of the vibratory dosing chute spaced apart from the first end of the vibratory dosing chute.

The vibratory dosing chute comprises two separate chutes positioned in parallel and wherein the vibratory driver is coupled between second ends of each of the two separate chutes.

The two separate chutes comprise a first chute and a second chute wherein the first chute is larger than the second chute.

The first chute comprises a ramp portion and a flat portion with the vibratory driver positioned proximate the flat portion of the chute.

Each of the two separate chutes are fixed to the chassis at the first end with one or more mounting pads such that the mounting pads and the vibratory driver are offset from one another along lengths of the chutes.

The one or more mounting pads are elastic mounting pads.

### BRIEF DESCRIPTION OF THE DRAWINGS

FIG. 1 is a side perspective view of a vibratory bean dosing appliance according to one or more embodiments described herein.

FIG. 2 is an exploded view of the vibratory bean dosing appliance.

FIG. 3 is a top view of the vibratory bean dosing appliance.

FIG. 4 is a top view of a base portion of the vibratory bean dosing appliance.

FIG. 5 is a top perspective view of a housing for a vibratory dosing system with delivery chute of the appliance.

FIG. 6 is a side perspective view of the housing.

FIG. 7 is a bottom view of the housing.

FIG. 8A is a perspective view of first and second vibratory dosing chutes with mounting and vibration source locations and isolated from a housing therefor for ease of illustration.

FIG. 8B is simplified stick diagram depicting, in side view, vibratory motion the vibratory dosing chutes where the amount of deflection is exaggerated for purposes of illustration.

FIG. 9 is a top perspective view of the housing and a second vibrating chute therein of the vibratory dosing system of the appliance and illustrating in further detail a mounting mechanism for the vibrating chute(s) in the housing.

FIG. 10 is a top perspective view of the housing and a second vibrating chute therein of the vibratory dosing system of the appliance and illustrating in further detail a location for a vibratory source mounting for vibrating the vibrating chute(s) in the housing.

FIG. 11 is a side perspective view vibratory dosing system comprising two vibrating dosing chutes.

FIG. 12 is a top view thereof.

FIGS. 13A-13B are a side perspective view of a bean dosing system according to one or more embodiments described herein.

FIG. 14 is a side perspective view of a base of the dosing system illustrated in FIG. 13.

FIG. 15 is a side perspective view of a bucket of the dosing system illustrated in FIG. 13.

FIGS. 16A and 16B are side and bottom perspective view of the bucket respectively.

FIGS. 17A-17C are a side perspective, front, and bottom perspective view of the bucket supported on the base of the dosing system.

FIGS. 18A-18C are a side perspective, top, and bottom view of the bucket supported on the base and with a dosing system with dosing chutes coupled to form an appliance.

FIGS. 19A-19B are a side perspective and top view of the bucket supported on the base and with a dosing system without dosing chutes coupled to form an appliance.

FIG. 20 is a flow diagram of an electrical circuit for the system.

FIG. 21 is a flow diagram of software logic for the system.

### DETAILED DESCRIPTION

Described herein is a bean hopper and vibratory dosing system. The appliance is configured to automatically and precisely measure and deliver a quantity of whole coffee beans into a container. In one or more embodiments the bean hopper and vibratory dosing system is provided in the form of an accessible in-home appliance capable of precisely weighing and dispensing, or dosing, beans in any preselected or arbitrary weight. It is also contemplated and within the scope of this disclosure that precision weights can be specified. For example, weighing of bean in the range of approximately 1 gram to 10 grams to 40 grams, or more, may be typical for home uses (e.g., espresso, pour over, etc.), with a precision of +/−0.2 grams or less, for example with a precision of +/−0.1 to 0.2 grams or approximately within +/−1 bean. While the system described herein includes reference to coffee beans, the dosing system may be used in connection with any dry good having an overall size, shape and/or weight similar to, less than or about as large as a coffee bean. Use of the vibratory dosing system described herein is not limited to coffee beans.

In one or more embodiments described herein, the dosing system or assembly utilizes one or more vibrating chutes to move beans from a hopper located above dosing chutes to a container located below the chutes. In one embodiment, the container may be manually positioned on a scale for confirmation of weight dispensed and additionally or alternatively the container comprises an internal reservoir with weight sensing capabilities and a moveable floor for releasing the contents collected in the container once the pre-selected weight is reached. In such embodiments, the container may be integral to the dosing system assembly, for example, supported above a base thereof.

In one or more embodiments described herein, the dosing system or assembly may be incorporated into an appliance or device for measuring and dispensing a preselected amount of dry goods, for example, coffee beans from a hopper into a container and/or removably coupled to a stand element having different constructions and/or functions for providing a custom appliance. Similarly, a reservoir for holding and dispensing the dry goods into the dosing system may also be removably coupleable to the dosing system of assembly. As such, in one or more embodiments, the dosing system or assembly is a first unit that is independent of a reservoir and/or a stand such that the components are separable and independently couplable to form an assembly that is modular in construction. Each piece can be provided on its own and the dosing system or assembly is capable of functioning separately from one or both of the reservoir and/or stand component. It is further contemplated and within the scope of this disclosure that an opening is provided in a bottom of the base. The opening may be any shape and size and is a hole through which dispensed beans drop. The device can be mounted on top of nearly any surface to allow bean dosing through this hole in the bottom of the base. The surface may be a stand that allows beans to drop directed to a catch cup or mounted directly on top of a coffee grinder, for example.

In one or more embodiments, a vibratory dosing system is comprised of a dosing chute that supports a plurality of dosing mechanisms therein. Each dosing mechanism comprises a length and an outlet opening at one end. At least one dosing mechanism comprises a ramped portion at one end opposite the outlet opening end. The ramped portion may generally be positioned below a hopper for receiving a supply of dry goods for dispensing. The second opposing end of each dosing mechanism is positioned proximate a dry good delivery or exit chute. A dedicated vibratory driver is coupled proximate the second opposing end of each dosing mechanism allowing the dosing mechanisms to be controlled independently. However, it is also contemplated and within the scope of this disclosure that each dosing mechanism is operably coupled to the same vibratory driver.

The dosing mechanisms are then configured for vertical movement effected at the second opposing end of the dosing mechanism, concurrently or independently from one another. The first end of each dosing mechanism is substantially static and/or substantially fixed in position such that vertical movement is concentrated at the second opposing end of each dosing mechanism. An clastic attachment mechanism may be provided and operably coupled to first ends of adjacent and parallel dosing chutes to reduce and/or eliminate vibration of the cutes at the first end. Thus, the dosing system comprises and is configured with an asymmetric suspension. This may reduce the vibratory coupling between the first and second dosing mechanisms which may each be driven by a vibratory driver that may be operably connected to each dosing chute and/or between adjacent chutes. The dosing system described herein may be provided on its own and/or may be provided in operable connection with or otherwise coupled to a hopper and configured to receive goods therefrom and/or a scale for measuring and thus controlling the dispensing of a precise pre-selected weight of dry goods from the dosing system.

In one or more embodiments, the exit chute of the dosing assembly, referred to also as the upper dosing assembly may comprise an internal or otherwise integrated bucket or other open top container which receives the dry goods directly or otherwise from the dosing mechanism(s) within the dosing assembly. The internal bucket or other open top container may further comprise a moveable floor akin to a “trap door” where, as the internal bucket receives dosed dry goods, the goods are weighed and once the pre-selected weight is met and/or matched within the set margin of error, the floor opens to dispense the dry goods. The “trap door” may comprise a servo motor, or other device such as a stepper motor or electrical/pneumatic solenoid to release and retract the moveable floor. The integrated bucket may also be referred to as a receptacle hereinafter. The receptacle may be suspended by a load cell which acts as a scale or weighing mechanism in an operation where a selected amount or weight of beans is dosed into the receptacle for actuation of the floor to release the selected amount or weight of beans. In such an embodiment, the chutes and the moveable floor are not in contact with the load cell to avoid and reduce measurement noise and/or error.

A base of dosing assembly may have an aperture which allows the dry goods released from the internal bucket through the floor thereof to exit the dosing assembly for access by a user. The bucket may also be suspended from the chassis of the upper dosing assembly via a load cell.

In one or more embodiments, the upper dosing assembly may be considered a universal assembly capable of mounting to one of a plurality of different stands where each stand may have a distinct structure and/or function. For example, the universal assembly may mount to a stand that is configured for a specific use, and moreover, the stand may be designed on demand for customer or end-user applications. In such an embodiment, the upper dosing assembly is provided as a separate assembly apart from but removably coupleable to a stand.

In one or more embodiments, the base of the housing may be provided with a plurality of mounting apertures. For example, 3, 6, 9 or more mounting apertures can be provided and configured to allow the housing to be coupled to one or more different stands for supporting the base, the housing and thus the appliance. Mounting of the dosing assembly to a stand may be done by one of various mechanisms including but not limited to frictional engagement of mating apertures and prongs or clips, straps, slidably interconnecting portions of the base and stand, threaded connections, magnetic connections or the like.

It is also contemplated and within the scope of this disclosure that the stands may be use-specific. For example, a stand may have a spout to dispense beans anteriorly into a bucket, and/or a stand may just suspend the device over a bowl, or other kitchen or bar accessory. One or more stands may have a specific geometry which indicates the stand is configured to work with specific pre-existing bean containers, cellars or the like.

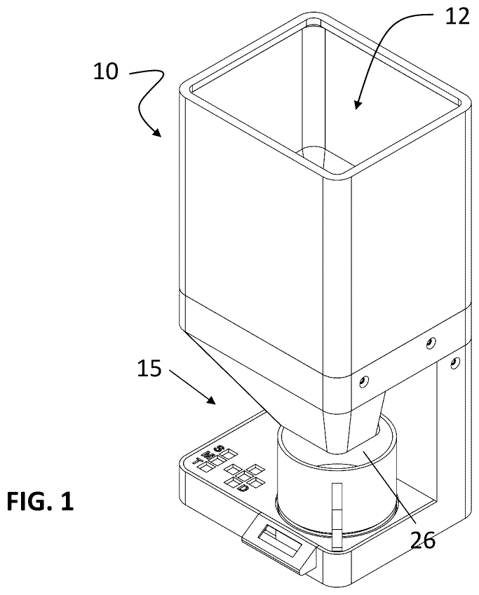

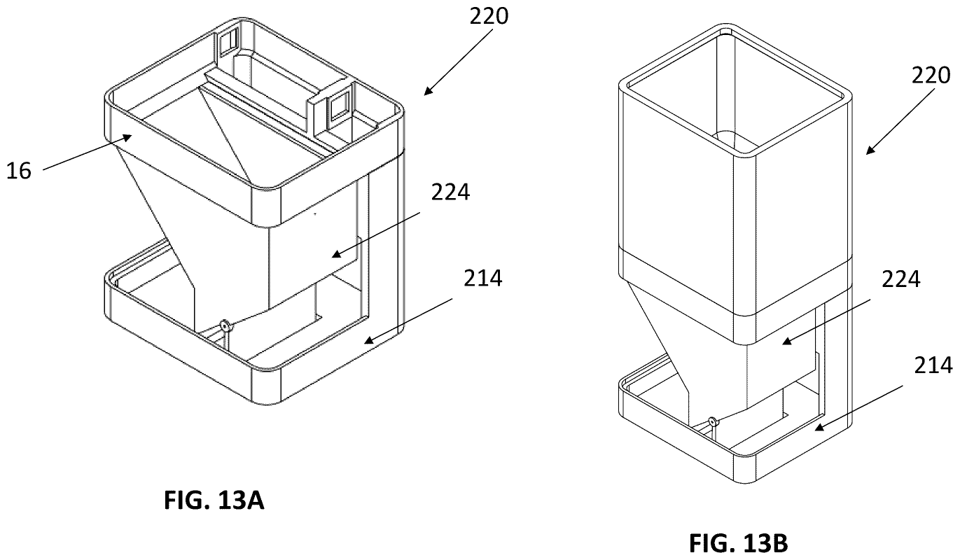

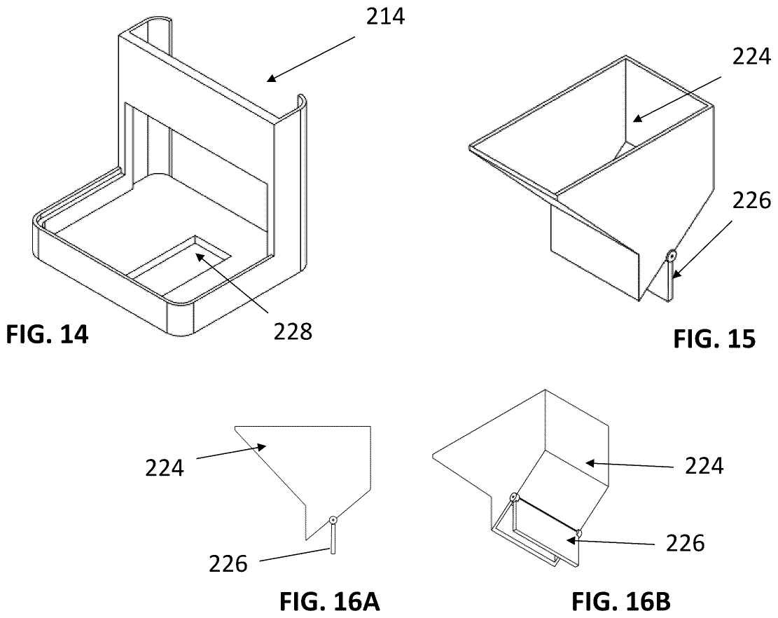

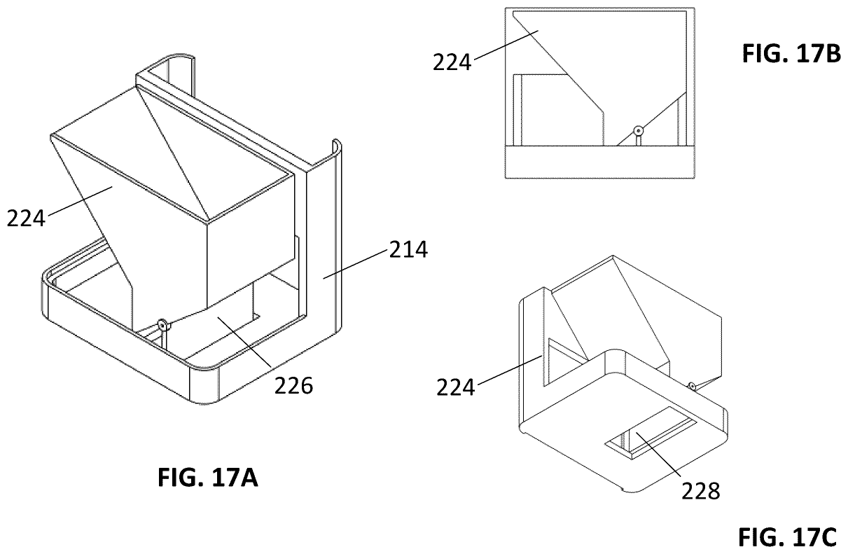

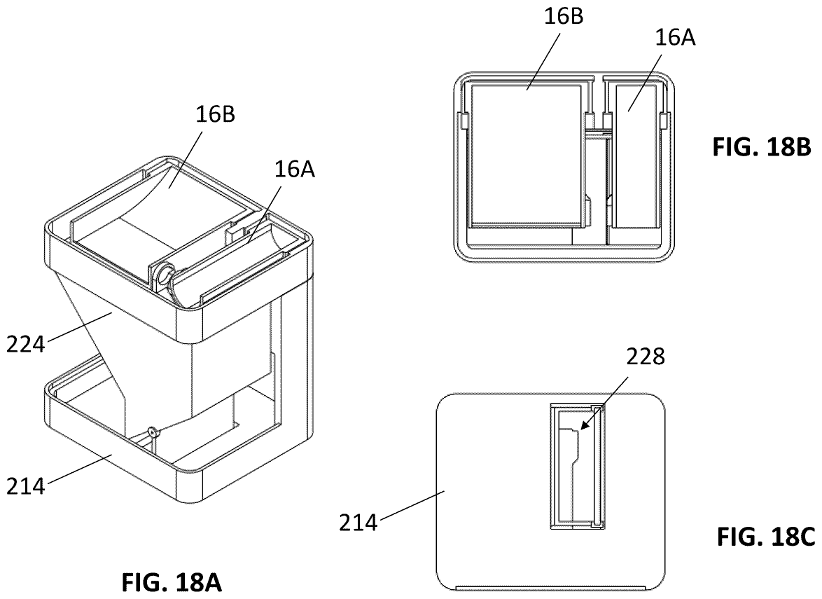

An embodiment of an appliance 10 comprising a bean hopper 12, scale 14, and vibratory dosing system 16 is illustrated generally in FIGS. 1-12. FIGS. 13-19B illustrate an additional or alternative embodiment thereof. In the embodiment of FIGS. 13-19B, the device may be modular in that the device can be mounted to another object or appliance as noted above. Referring first to FIGS. 1-12, for example, the appliance 10 comprises a housing 100 which may comprise a top portion 112 and a base portion 114. The top portion 112 supports the bean hopper 12, whereas a chassis 28 is provided below the top portion 112 for receiving beans from the hopper 12 and above the base portion 114 to deliver measured quantities from the hopper 12 to the scale 14. The chassis 28 supports the vibratory dosing system 16 and an optional bean dispensing guide 24 which directs beans to the base section 114 which comprises a scale 14 and control interface 18 screen for operation of the appliance 10 including selecting a weight of beans to be dosed and dispensed. The scale 14 may be configured to support a receiving container 26 such as a cup for receipt of dosed beans. In an additional or alternative embodiment illustrated in FIGS. 13-19B, the bean dispensing guide 24 is omitted and is not required when an internal bucket 224 is incorporated, as a catchment area of the bucket 224 is much larger than a catch cup. No guide or funnel is needed and is thus optional.

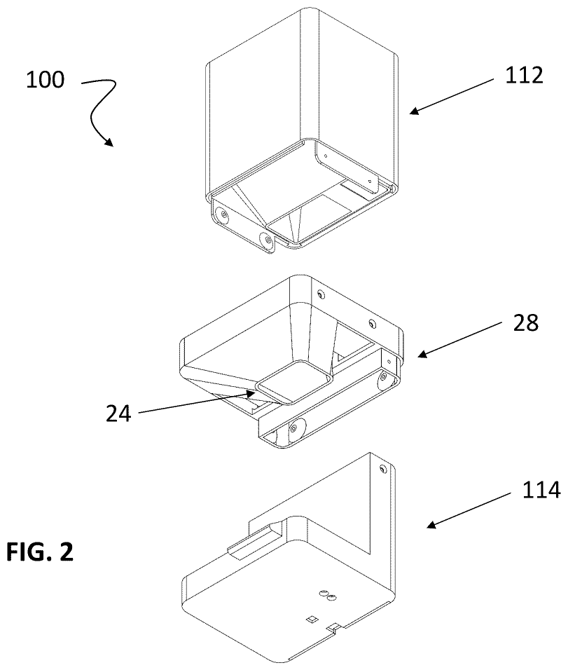

As shown in FIG. 2, the dosing mechanism 16 is illustrated in connection with a base 114 of the appliance 10. The hopper 12 may be positioned to sit directly above the dosing mechanism 16. The exit chute bean guide 24 serves to redirect the beans from wide lateral distribution upon exiting the chutes 16A, 16B to a smaller aperture suitable for a small container 26. Further, the housing 100 may be constructed of various materials including stainless steel, hard plastics and combinations thereof. Each of the top portion 112, chassis 28 and base 114 together form the housing 100 and these components may be operably connected to house the internal components including the dosing system 16 and electronics therefor. These components may be assembled and secured via fasteners, friction fitting of the components such as the interlocking and/or coupling together of complimentary surfaces, adhesives, or combinations thereof.

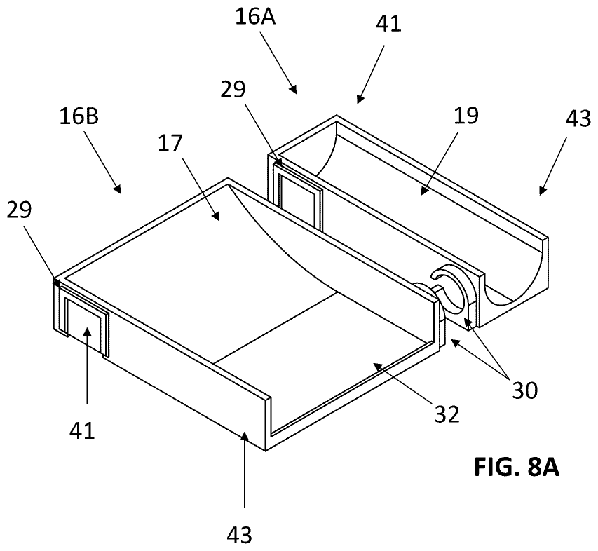

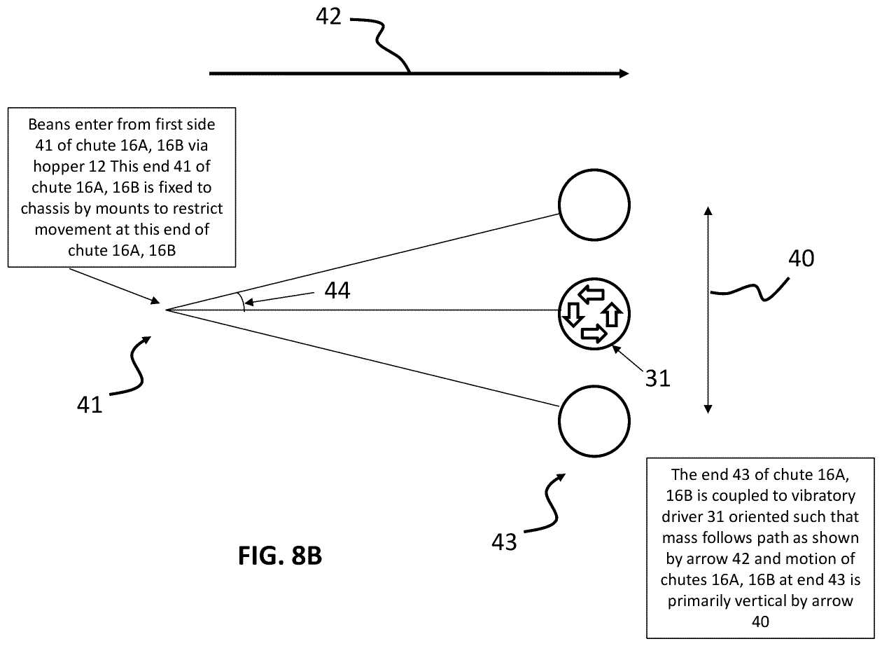

In further detail and as illustrated in the figures, whole beans are provided to the hopper 12 and may be fed by gravity into one or more vibratory chutes 16A, 16B of the vibratory dosing system 16. In the embodiment illustrated the vibratory dosing system 16 comprises two parallel vibrating chutes 16A and 16B. As shown in further detail in FIG. 8, chute 16B has a “ramp” at an input end 41. As discussed in further detail below, both chutes are perpendicular to the direction of gravity at an exit end 43. When the system is in an “off” state, the beans do not flow down the chutes 16A and 16B and/or out of the hopper 12 due to static friction.

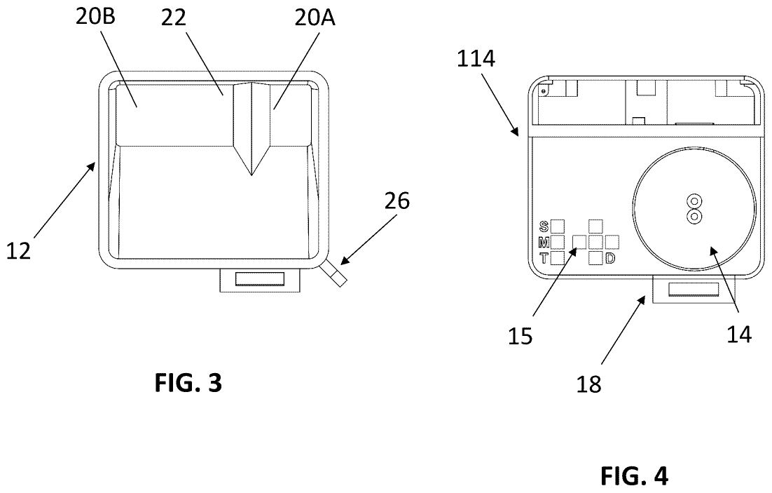

As shown in FIG. 3, the appliance or device 10 comprises hopper openings 20A and 20B and a bean splitter 22 that statically directs beans in the hopper 12 into one of the two chutes 16A and 16B. A bean exit guide chute 24, which funnels the beans from a dosing mechanism to a specific location above where the receiving container 26, may be positioned as illustrated in the figures.

A user primarily interacts with the system 16 by filling the device 10 with beans from the top or otherwise loading the beans into the hopper 12. Key information may be provided on the appliance interface screen 18 and the user may then select appliance functions using one or more interface buttons 15 as shown in FIG. 4.

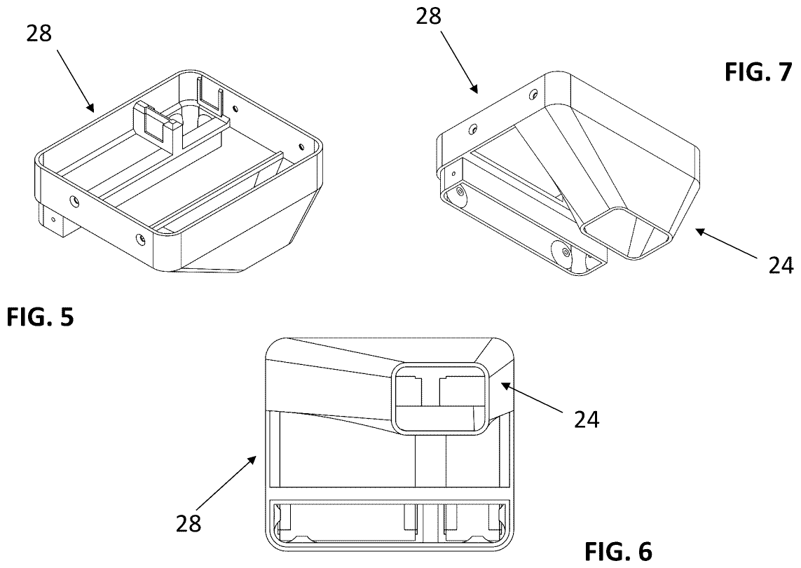

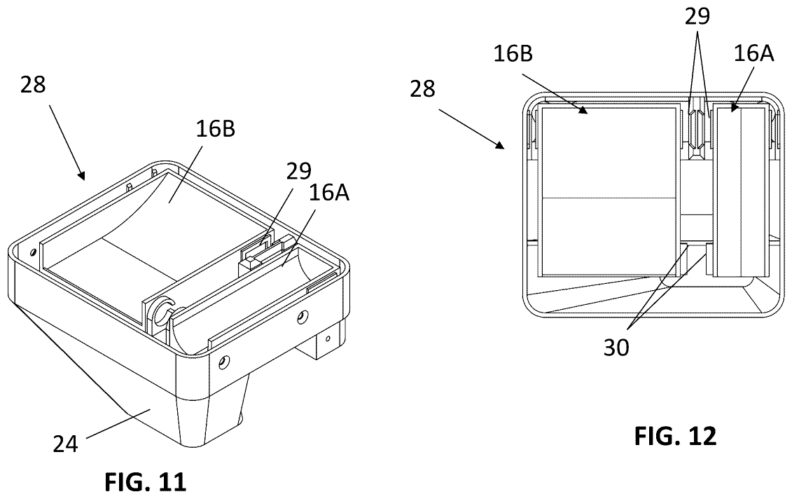

A dosing mechanism 16 is illustrated in FIGS. 5-10 and FIGS. 18A, 18B and more specifically in FIGS. 11-12. For example, two vibratory chutes 16A and 16B are depicted in respective locations relative to a chassis 28 of the appliance 10. The chutes 16A and 16B are also illustrated in a mounting position, but without the chassis 28 for ease of illustration. Beans enter one or both of the chutes 16A and 16B from above, in the portion of the chutes 16A and 16B positioned below the hopper 12. Due to both the shape of the chute 16A, 16B and the weight of the beans above the chutes 16A, 16B in the hopper 12, as the chutes 16A and 16B vibrate, the beans flow down the chute 16A, 16B and drop out through the bean exit chute 24. Precise dispensing of beans can be facilitated by the curvature 19 and narrow width of the smaller chute 16A, which is distinct from the larger chute 16B, which comprises a ramp 17 along a portion thereof. The chutes 16A, 16B may be configured to dispense different amounts of beans. For example, one chute is configured to dispense a larger amount of beans and a second chute is configured to dispense a smaller amount of beans. In operation, the first chute 16B is activated to dispense a large amount of beans less than the pre-selected weight of beans requested. The second chute 16A is then activated to dispense the remaining beans required to reach the pre-selected weight of beans. The chutes 16A, 16B are described in further detail below.

A vibratory driver, one non limiting example being an eccentric rotating mass (ERM) vibration motor, may be affixed to each chute 16A, 16B at mounting mechanism 30. The vibratory driver positioned at mounting 30 provides the vibratory motion essential to the chute 16A, 16B functions. The chutes 16A, 16B comprise a small chute 16A and a large chute 16B. The large chute may provide high volume bean delivery. However, in some embodiments, the high volume delivery may be provided with a smaller degree of precision in total weight delivered vs total weight selected. The small chute may provide high precision delivery of beans in smaller volumes. As such, the small chute 16A has a curved profile 19 to encourage beans to travel down the chute in a “single file” line, which allows single bean dropping precision. The large chute 16B may also have a small flow restricting lip 32. The flow restricting lip 32 reduces and/or eliminates unwanted bean droppage from the large chute 16B when the small chute 16A is activated, and thus also unavoidably transmitting a small amount of vibration into the larger chute 16B.

FIG. 8A shows the dosing chutes 16A, 16B in isolation and FIG. 8B illustrates a simplified stick diagram of the motion of the vibratory chutes 16A, 16B where the deflection is exaggerated for illustration and the displacement angle 44 is sufficient to impart vibration to the chute 16A, 16B to move beans along the direction of mass transfer according to arrow 42. For example, the left side of the diagram is the proximal or feeding end 41 of the chute 16A, 16B, just below the hopper 12 opening. This proximal end 41 of the chute 16A, 16B is fixed to the chassis 28 via one or more elastic attachments at attachment mechanism 29 which may comprise clastic and/or flexible mounts, including for example, flexible hardware. These elastic attachment mechanism 29 allow for the transmission of vibration and may comprise spring like properties, for example, in addition to rubber pads, metal leaf springs, metal coil springs, or any rubberized polymer (clastic) may be used for the elastic attachments. By nature of the moment arm generated by the length of the chute 16A, 16B, the vibratory driver 31 is only able to impart significant vertical motion 40 to the chute 16A, 16B at the opposite end 43 of the chute 16A, 16B, with little to no motion in the horizontal direction. Furthermore, the absolute displacement of the chute 16A, 16B is greater the closer the bean is along the length of the chute 16A, 16B to the vibratory motor, for example, at the second end 43 of the chute 16A, 16B or exit end of the chute. In practice, this reduces the amount of vibration transmitted to the chassis 28 of the device, which allows the two chutes 16A, 16B to function independently.

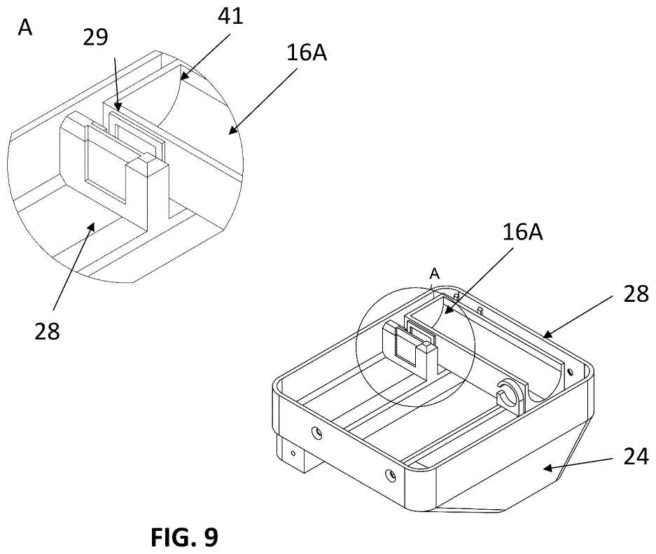

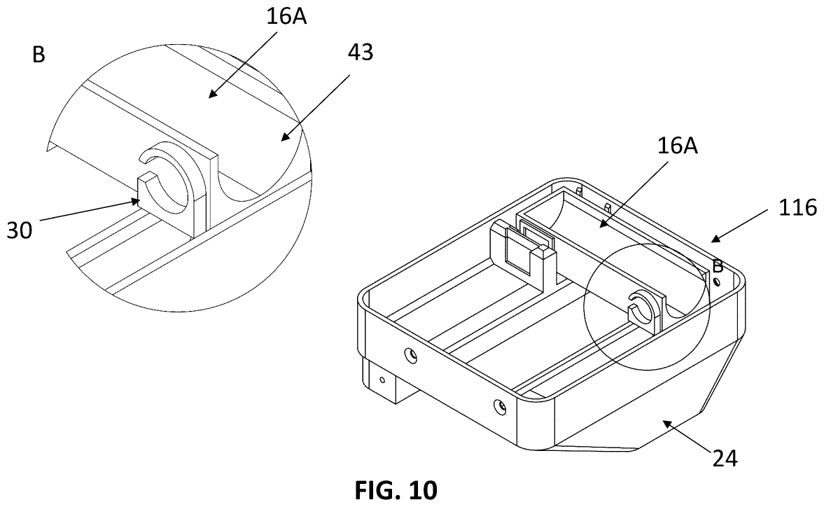

FIGS. 9 and 10 illustrate the small chute 16A alone and in relation to the chassis 28 of the system 16. A mounting location 30 of the vibratory driver 31, which in the embodiment illustrated is an ERM motor. Vibratory motion of the small chute 16A is illustrated by arrow 40, while this motion is the same for the large chute 16B. Elastic attachments such as rubber mounting hardware connect the chute 16A, 16B to the chassis at mounting 29, however for illustration purposes the pad may be omitted from view. FIG. 10 provides a closer view of an embodiment of a vibratory driver mount 30, which may be a circle with a small slot on one side. This allows the driver, such as an ERM motor, to be press-fit into place. The slot allows the wires an exit route.

In the embodiments illustrated in the figures, the particular arrangement of the vibratory driver and the flexible and/or absorbing mounting pads at opposite ends 41, 43 of the chute 16A, 16B illustrates a novel aspect of the appliance 10. The appliance 10 described herein is distinct from a vibratory conveyor used in unrelated applications in the prior art.

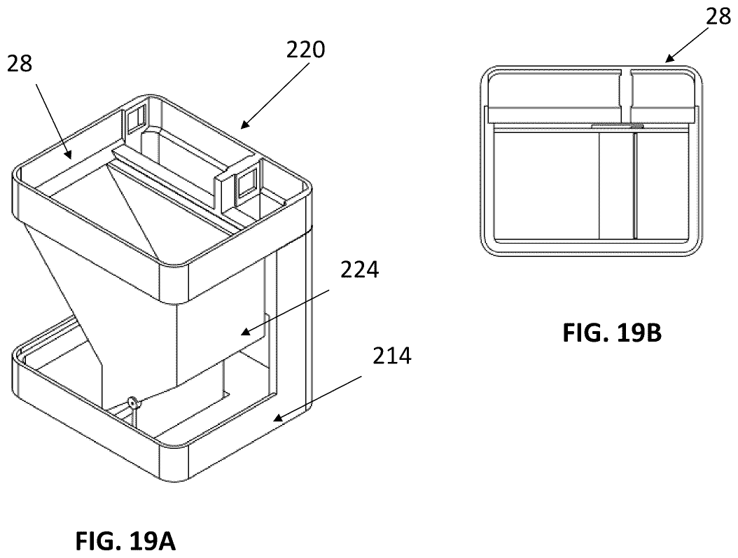

Referring to the embodiment illustrated in FIGS. 13-19B, the elements can be incorporated into a system shown at 220. The dosing system 16 can be incorporated into a modular appliance that comprise a base 214 and a reservoir or bucket 224 with a floor 226 that can drop to open and may have a hinge or other connection on one end configured to allow for opening and closing of the floor 226 to release and hold beans therein with respect to the reservoir or bucket 224. The dosing mechanisms 16A, 16B are a first unit 16 that is independent from and/or other otherwise integrated with the reservoir 224 and wherein the dosing mechanism 16 and/or reservoir 224 are supported on the base 214. The system 220 can be provided on its own and coupled to a coffee grinder, or other devices, stands, appliances or the like. The reservoir 224 may be suspended from the chassis 28 below the dispensing mechanisms 16A, 16B. The system 220 is illustrated without the dosing mechanism 16 in FIGS. 19A, 19B.

An opening 228 is provided in a bottom of the base 214 and is positioned to accept material from the reservoir 224 as the door 226 opens. The opening 228 may be any shape and size and is a hole through which dispensed beans drop. The base 214 supports the reservoir 224 and dosing mechanisms 16A, 16B for operation, and the base 214 may have a plurality of mounting fixtures, elements, or apertures which allow the base 214 to be mounted and/or used with various stands, housings, containers, or other appliances.

A key aspect of a traditional vibratory conveyor design is symmetric suspension of the vibrating surface with a centered driving mechanism such that the vibrating surface has a uniform displacement direction and amplitude. In contrast, the appliance described herein has a chute design that does not follow this uniform motion that characterizes vibratory conveyors. The driving mechanism described herein is not designed to, nor configured to create uniform vibrating surface motion, but rather is configured for increased motion at the distal end of the chute. Unlike true vibratory conveyors, the appliance described herein does not have the same suspension mechanism requirements as a vibratory conveyor and does not require a robust mounting base to absorb the induced vibration as such prior art vibratory conveyors require. In the appliance described herein, such prior art vibratory conveyors would actually induce vibrations caused by a traditional vibratory conveyor design that would result in coupling between the two chutes, and result in unwanted dosing behavior.

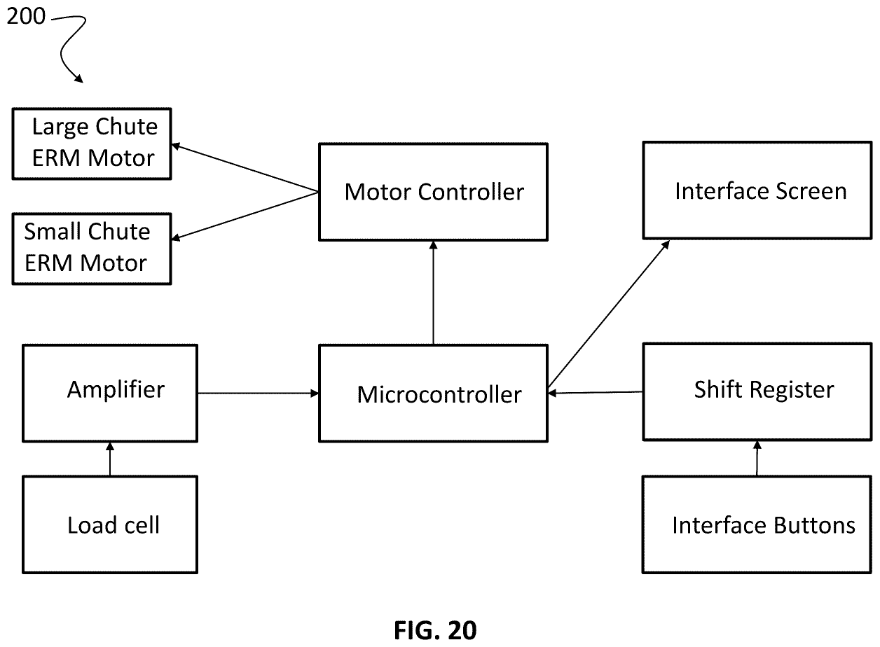

An electrical system 200 of the appliance 10 may comprise one or more general circuits for powering the appliance. A block diagram of one embodiment which incorporates six circuits is shown in FIG. 20. A microcontroller is provided for dosing control logic and for controlling the remaining electric systems; as well as a scale; a vibration system; display unit; interface buttons; and power source. For example, the scale circuit, which may be a 300g load cell scale with an amplifier, allows the scale to provide the weight measurements used to dose the beans accurately. The vibration system comprises the vibratory driver(s), such as one ERM vibration motor per chute, each driven by a transistor or in an alternative embodiment by a linear resonant actuator (LRA) with a dedicated LRA driver circuit. An interface screen may be an OLED display screen. Interface buttons may include momentary switches read via a shift register to reduce the number of digital inputs required on the microcontroller. The power supply for the appliance may comprise a 5v linear voltage regulator to supply the electrical system with 5v from a 12v DC input, or a rechargeable battery coupled to a battery management circuit. Depending on the ERM or LRA voltage requirements, or any other component in the electrical system, a variety of voltage regulators, including buck-boost circuits, may be used to supply the required voltages.

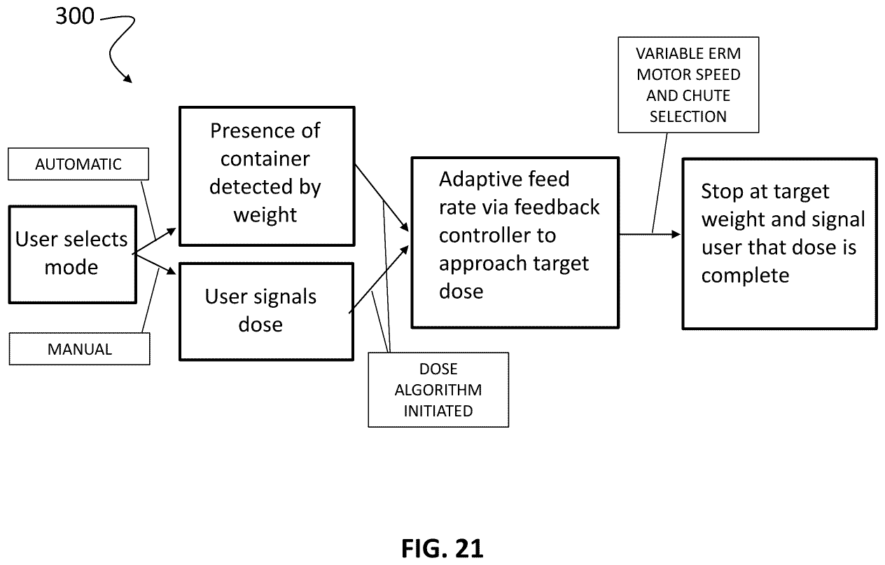

Software logic may be provided for controlling measuring and dispensing from the appliance. In one embodiment, the logic structure 300 follows the flowchart illustrated in FIG. 21. There may be two modes of operation: manual and automatic. For example, in manual mode, a user presses a button to signal the device to dose a desired weight. In automatic mode, the scale detects the presence of a container as the signal to dose the target weight. In both modes, the dosing algorithm used to achieve the target weight may be the same after dosing is initiated. It is also contemplated that the appliance learns from previous doses to adjust various parameters to increase the speed and accuracy of future doses.

In one or more embodiments, the user interface screen may be mounted on a hopper face or may be mounted on the base near the scale to provide an improved viewing angle of the interface.

In one or more embodiments, the chute surface within the bean travel path of one or both chutes may be flat and substantially smooth. In one or more embodiments, the chute surface may have a texture or surface topography. For example, such surface texture may comprise ridges, wavelets, or triangular surface textures to control bean flow through the chute. Additionally, or alternatively, surface coatings such as a layer of rubber, silicone or other materials which provide a coefficient of friction, compliance, and/or texture as compared with a plastic chute form may be incorporated. One or both chutes may have a ramped surface along part or all of the length of the chute.

Although the present disclosure has been described with reference to preferred embodiments, workers skilled in the art will recognize that changes may be made in form and detail without departing from the spirit and scope of the disclosure.

1. An automatic precision bean dosing device, the device comprising:
a housing comprising:
a base having an opening therein;
a reservoir supported on the base;
a chassis supporting a dosing chute for transferring one or more beans received therein to the reservoir supported by the base, wherein the dosing chute is a vibratory dosing chute coupled with a vibratory driver for vibrating the dosing chute;
a scale for weighing the one or more beans transferred from the dosing chute to the reservoir.

2. The device of claim 1, wherein the dosing chute comprises a first dosing chute and a second dosing chute and one or more elastic attachments providing an asymmetric suspension for the dosing chute to reduce vibratory coupling between the first and second dosing chutes.

3. The device of claim 1, wherein the reservoir is configured to hold a selected amount of beans transferred thereto and further configured to automatically release the beans when the weight of beans in the reservoir meets a preset weight.

4. The device of claim 2 wherein the first dosing chute is configured for dosing a first selected quantity of beans and the second dosing chute comprises a ramp for precision dosing of a second selected quantity of beans and, wherein the first quantity of beans is greater than the second quantity of beans.

5. The device of claim 1 wherein the vibratory driver is positioned at one end of the dosing chute to generate asymmetric displacement along a length of the dosing chute.

6. The device of claim 1 wherein beans are transferred from the hopper into a first end of the dosing chute and wherein the first end of the dosing chute is fixed to a chassis by a flexible mount to restrict movement of the dosing chute at the first end.

7. The device of claim 6 wherein a second end of the dosing chute comprises a vibratory driver oriented to provide vertical motion at the second end of the dosing chute and wherein the one or more beans travel from the hopper to the first end of the dosing chute, along a length thereof and to the second end of the dosing chute and to the exit chute positioned at the second end of the dosing chute.

8. The device of claim 6 wherein the vibratory driver comprises an eccentric rotating mass vibration motor or linear resonant actuator to provide vertical motion to at least a portion of the length of the dosing chute originating at the second end of the dosing chute.

9. The device of claim 2 wherein the second dosing chute comprises a curvature and width narrower than the first dosing chute such that the one or more beans travel a length of the second dosing chute in a single file manner.

10. The device of claim 2 wherein the first dosing chute comprises a ramp at a first end for receiving beans from the hopper and wherein each of the first and second dosing chutes is oriented perpendicular to the direction of gravity at an exit end of the dosing chute proximate the exit chute.

11. A vibratory dosing system comprising:
a dosing chute having a first dosing mechanism and a second dosing mechanism, the first dosing mechanism comprising a ramp at a first end and wherein a second end of each dosing mechanism is proximate an exit chute;
a vibratory driver coupled proximate the second end of one or both dosing mechanisms and configured to vertically move the second end of one or both dosing mechanisms to vibrate one or both dosing mechanism; and
one or more elastic attachments mounted on an opposing end of the first and second dosing mechanisms from the vibratory driver for providing an asymmetric suspension for the dosing chute or to reduce vibratory coupling between the first and second dosing mechanisms.

12. The system of claim 11 and further comprising a receptacle below the dosing chute and configured to receive material from the dosing chute and wherein the receptacle comprises a floor that is movable to release material from the receptacle.

13. The system of claim 12 wherein a scale is integrated into the receptacle, and is operably connected to the movable floor of the receptacle.

14. The system of claim 11 and further comprising a base connectable to the dosing chute and receptacle, the base comprising an aperture therein for allowing material released from the receptacle to be delivered therethrough.

15. An automatic precision bean dosing device, the device comprising:
a chassis comprising:
a vibratory dosing chute for transferring one or more beans provided thereto to an exit thereof, wherein the vibratory dosing chute has a first end and a second end, and wherein the second end is positioned above a reservoir for receiving beans from the dosing chute;
a vibratory driver coupled to a second end of the vibratory dosing chute spaced apart from the first end of the vibratory dosing chute.

16. The device of claim 15 wherein the vibratory dosing chute comprises two separate chutes positioned in parallel and wherein the vibratory driver is coupled between second ends of each of the two separate chutes.

17. The device of claim 16 wherein the two separate chutes comprise a first chute and a second chute wherein the first chute is larger than the second chute.

18. The device of claim 17 wherein the first chute comprises a ramp portion and a flat portion with the vibratory driver positioned proximate the flat portion of the chute.

19. The device of claim 16 wherein each of the two separate chutes are fixed to the chassis at the first end with one or more mounting pads such that the mounting pads and the vibratory driver are offset from one another along lengths of the chutes.

20. The device of claim 19 wherein the one or more mounting pads are clastic mounting pads.
